(19) United States
(12) Patent Application Publication
(10) Pub. No.: US 2025/0355315 A1
(43) Pub. Date: Nov. 20, 2025

(54) POLARITON DEVICE, POLARITON SYSTEM, METHOD OF MANUFACTURING POLARITON DEVICE, AND METHOD OF CONTROLLING POLARITON DEVICE

(71) Applicant: Daegu Gyeongbuk Institute of Science and Technology, Daegu (KR)

(72) Inventors: Hyeon-Seo CHOI, Daegu (KR); Chang-Hee CHO, Daegu (KR); Taejin LEE, Daegu (KR)

(21) Appl. No.: 18/826,538

(22) Filed: Sep. 6, 2024

(30) Foreign Application Priority Data
May 14, 2024 (KR) 10-2024-0063010

(51) Int. Cl. G02F 1/35; G06N 10/40

(52) U.S. Cl. CPC G02F 1/353; G02F 1/3503; G06N 10/40

(57) ABSTRACT

Provided are a polariton device, a polariton system, a method of manufacturing the polariton device, and a method of controlling the polariton device. The polariton device includes a cavity including a gain layer including a ferroic material that undergoes a phase transition into an asymmetrical crystal structure in response to an external stimulus, an upper reflective layer formed on top of the cavity, a lower reflective layer formed below the cavity, and a Rabi frequency controller configured to control a Rabi frequency of the polariton device by providing a stimulus to the gain layer.

### CROSS-REFERENCE TO RELATED APPLICATION

This application claims priority to and the benefit of Korean Patent Application No. 10-2024-0063010 filed in the Korean Intellectual Property Office on May 14, 2024, the entire contents of which are incorporated herein by reference.

### BACKGROUND

### (a) Field

The disclosure relates to a polariton device, a polariton system, a method of manufacturing a polariton device, and a method of controlling a polariton device.

### (b) Description of the Related Art

A polariton device is an optoelectronic device that utilizes the strong interaction between photons and excitons, and may be based on a quasiparticle called a polariton, which has the characteristics of both light and matter. Since both optical and electronic properties may be controlled through polariton devices, polariton devices have come to prominence in various fields, such as optical switches, quantum computing, and quantum communication systems. The performance of polariton devices may be closely related to the Rabi frequency. The Rabi frequency is a frequency that occurs when an external optical field interacts with a particle in a quantum system and may indicate the strength of coupling between photons and excitons. By adjusting the Rabi frequency, the optical and electronic properties of polariton devices may be precisely controlled, and through this, the luminous efficiency, an operating speed, and responsiveness of polariton devices may be optimized.

### SUMMARY

The disclosure attempts to provide a polariton device, a polariton system, a method of manufacturing the polariton device, and a method of controlling the polariton device, capable of effectively adjusting the Rabi frequency, without changing a design structure of the polariton device or adopting a complicated system.

According to an example embodiment, a polariton device includes: a cavity including a gain layer including a ferroic material that undergoes a phase transition into an asymmetrical crystal structure in response to an external stimulus; an upper reflective layer formed on top of the cavity; a lower reflective layer formed below the cavity; and a Rabi frequency controller configured to control a Rabi frequency of the polariton device by providing a stimulus to the gain layer.

In some example embodiment, the ferroic material may include a perovskite material having an ABX₃ structure (A: positive ion, B: metal ion, C: halogen ion or oxygen).

In some example embodiment, the polariton device may further include a temperature control device configured to provide a temperature change stimulus to the gain layer, wherein the Rabi frequency controller may control the Rabi frequency of the polariton device by changing the temperature change stimulus provided to the gain layer through the temperature control device.

In some example embodiment, the polariton device may further include a substrate having an upper surface supporting the lower reflective layer, wherein the temperature control device may be formed and attached to a lower surface of the substrate.

In some example embodiment, the polariton device may further include an electrical control device configured to provide an electrical change stimulus to the gain layer, wherein the Rabi frequency controller may control the Rabi frequency of the polariton device by changing an electrical change stimulus provided to the gain layer through the electrical control device.

In some example embodiment, an electrode may be formed in the gain layer, and the electrical control device may be electrically connected to the gain layer through the electrode.

In some example embodiment, the polariton device may further include a qubit generating unit configured to generate a polariton qubit implemented based on polariton, wherein the Rabi frequency controller controls a probability distribution of an upper polariton or a lower polariton of the polariton device by providing a stimulus to the gain layer, and the qubit generating unit generates a qubit having an occupation state determined depending on the controlled probability distribution.

In some example embodiment, at least one of the upper reflective layer and the lower reflective layer may be formed by alternately stacking first and second dielectric layers having different refractive indices, a refractive index of the first dielectric layer is greater than a refractive index of the second dielectric layer, the first dielectric layer may include at least one of ZnS, TiO₂, Si₃N₄, Nb₂O₅, ZnSe, and Ta₂O₅, the second dielectric layer may include at least one of SiO₂ and MgF₂, and the ferroic material may include MAPbBrs, MAPbl₃, MAPbCl₃, CsPbBrs, or BiFeO₃.

In some example embodiment, the upper reflective layer may be formed on top of the cavity according to a direct deposition method.

According to an example embodiment, a polariton system including a polariton device includes: a polariton device including a gain layer including a ferroic material that undergoes a phase transition into an asymmetrical crystal structure in response to an external stimulus; a Rabi frequency control device configured to control a Rabi frequency of the polariton device by providing a stimulus to the polariton device; and a quantum state control device configured to control a quantum state based on the controlled Rabi frequency.

In some example embodiment, the quantum state control device may provide a qubit for a quantum computer generated by controlling the quantum state.

In some example embodiment, the quantum state control device may control the level of quantum encryption by controlling the quantum state.

In some example embodiment, the quantum state control device may finely adjust strength of an optical signal for an optical modulator by controlling the quantum state.

According to an example embodiment, a method of manufacturing a polariton device includes: providing a substrate; forming a lower reflective layer on the substrate; forming a cavity, including a gain layer including a ferroic material that undergoes a phase transition into an asymmetrical crystal structure in response to an external stimulus, on the lower reflective layer; and forming an upper reflective layer on the cavity, wherein the Rabi frequency of the polariton device is controlled according to a stimulus provided to the gain layer.

In some example embodiment, the ferroic material may include a perovskite material having an ABX₃ structure (A: positive ion, B: metal ion, C: halogen ion or oxygen).

In some example embodiment, the method of manufacturing a polariton device may further include forming a temperature control device on a lower surface of the substrate, wherein the Rabi frequency of the polariton device is controlled according to a temperature change stimulus provided to the gain layer through the temperature control device.

In some example embodiment, the forming of the cavity may further include forming an electrode on the gain layer, and wherein the method of manufacturing a polariton device may further include connecting an electrical control device through the electrode, wherein the Rabi frequency of the polariton device is controlled according to an electrical change stimulus provided to the gain layer through the electrical control device.

In some example embodiment, the forming of the upper reflective layer may include forming the upper reflective layer on the cavity according to a direct deposition method.

According to an example embodiment, a method of controlling a polariton device includes: providing a polariton device manufactured by the method of manufacturing a polariton device described above and controlling a probability distribution of an upper polariton or a lower polariton of the polariton device by providing a stimulus to the polariton device.

In some example embodiment, the method of manufacturing a polariton device may further include generating a qubit with an occupation state determined according to the controlled probability distribution.

### BRIEF DESCRIPTION OF THE DRAWINGS

FIG. 1 is a diagram illustrating a polariton device according to an example embodiment.

FIG. 2 is a diagram illustrating a polariton system according to an example embodiment.

FIG. 3 is a diagram illustrating an implementation example of a gain layer according to an example embodiment.

FIG. 4 is a diagram illustrating current switching characteristics of a ferroic material according to an example embodiment.

FIG. 5 is a diagram illustrating polarization characteristics of a ferroic material according to an example embodiment.

FIGS. 6 and 7 are diagrams illustrating dispersion curves of a polariton device according to an example embodiment.

FIG. 8A is a diagram illustrating an example of a change in strength of an exciton oscillator by a polariton device according to an example embodiment, and FIG. 8B is a diagram illustrating an example of a change in the Rabi frequency by a polariton device according to an example embodiment.

FIG. 9 is a diagram illustrating a dispersion curve when an upper reflective layer is formed using different methods in a polariton device according to an example embodiment.

FIG. 10 is a diagram illustrating a method of manufacturing a polariton device according to an example embodiment.

FIG. 11 is a diagram illustrating a method of controlling a polariton device according to an example embodiment.

FIG. 12 is a diagram illustrating a method of manufacturing a polariton device according to an example embodiment.

### DETAILED DESCRIPTION

Hereinafter, reference will be now made to the example embodiments of the disclosure with reference to the attached drawings in a manner sufficiently detail to be readily carried out by a person skilled in the art, to which the disclosure pertains. As those skilled in the art would realize, the described example embodiments may be modified in various different ways, all without departing from the spirit or scope of the disclosure. Accordingly, the drawings and description are to be regarded as illustrative in nature and not restrictive. Like reference numerals designate like elements throughout the specification.

Throughout the specification and claims, unless explicitly described to the contrary, the word “comprise”, and variations, such as “comprises” or “comprising”, will be understood to imply the inclusion of stated elements but not the exclusion of any other elements. It will be understood that, although the terms first, second, etc. may be used herein to describe various elements, these elements should not be limited by these terms. These terms are only used to distinguish one element from another.

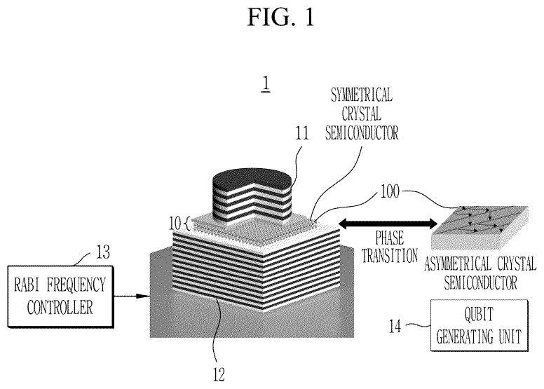

FIG. 1 is a diagram illustrating a polariton device according to an example embodiment.

Referring to FIG. 1, a polariton device 1 according to an example embodiment may include a cavity 10, an upper reflective layer 11, and a lower reflective layer 12.

The cavity 10 may include a gain layer 100, and the gain layer 100 may include a ferroic material that undergoes a phase transition into an asymmetrical crystal structure in response to an external stimulus. Here, the external stimulus may include a stimulus due to temperature change or a stimulus due to an electrical change. As ferroicity develops in the asymmetrical crystal structure, the Rabi frequency of the polariton device may change.

Here, the ferroic material of the gain layer 100 may represent a material whose electrical or magnetic properties change due to external force, such as electric and magnetic fields. Ferroicity may be revealed when the arrangement of atoms or molecules in a material is asymmetric or in a polar material. In particular, a phenomenon in which electrical polarization occurs due to an external electric field is referred to as ferroelectricity. Electrical polarization varies in size depending on the magnitude and direction of voltage applied to a material in a polarization voltage curve (or a polarization electric field curve) and may appear in a circular form of polarization.

The ferroic material may include a perovskite material. Specifically, the ferroic material may include a perovskite material having an ABX₃ structure (A: positive ions (e.g., MA, Cs, FA, etc.), B: metal ions (e.g., Pb, Sn, Fe, etc.), C: halogen ions or oxygen). Perovskite materials may have a structure that exhibits ferroicity in terms of a crystal structure of a material, the arrangement and mobility of ions, and interactions between ions. In addition, the ferroic material may include even a perovskite-like structure. For example, the ferroic material may include MAPbBrs, MAPbl₃, MAPbCl₃, CsPbBrs, or BiFeO₃.

In some example embodiments, the gain layer 100 may be formed to have various structures. For example, the gain layer 100 may be formed of a thin film, a single crystal, or a ring-shaped nanostructure.

The upper reflective layer 11 may be formed on top of the cavity 10. The upper reflective layer 11 may include a distributed Bragg reflector (DBR). Specifically, in order to form a reflective layer capable of securing high reflectivity, two types of dielectric thin films having a large difference in refractive index may be alternately stacked. That is, the upper reflective layer 11 may be formed by alternately stacking first and second dielectric layers having different refractive indices, and a refractive index of the first dielectric layer may be greater than a refractive index of the second dielectric layer. In the upper reflective layer 11, the first dielectric layer may include, for example, at least one of ZnS, TiO₂, Si₃N₄, Nb₂O₅, ZnSe, and Ta₂O₅. Meanwhile, the second dielectric layer may include, for example, at least one of SiO₂ and MgF₂. Such an upper reflective layer 11 may be formed through an electron beam (E-beam) evaporator, plasma enhanced chemical vapor deposition (PECVD), sputtering, etc.

The lower reflective layer 12 may be formed below the cavity 10. Like the upper reflective layer 11, the lower reflective layer 12 may also include a distributed Bragg reflector in which two dielectric thin films having a large difference in refractive index are alternately stacked. That is, the lower reflective layer 12 is formed by alternately stacking first and second dielectric layers having different refractive indices, and a refractive index of the first dielectric layer may be greater than a refractive index of the second dielectric layer. In the lower reflective layer 12, the first dielectric layer may include, for example, at least one of ZnS, TiO₂, Si₃N₄, Nb₂O₅, ZnSe, and Ta₂O₅. Meanwhile, the second dielectric layer may include, for example, at least one of SiO₂ and MgF₂. The lower reflective layer 12 may be formed through an E-beam evaporator, PECVD, sputtering, etc.

In some example embodiments, the upper reflective layer 11 and the lower reflective layer 12 may be formed using the same method. Specifically, the upper reflective layer 11 may be formed on top of the cavity 10 using a direct deposition method, and the lower reflective layer 12 may also be formed below the cavity 10 using a direct deposition method. Accordingly, the quality factor (Q-factor) of the polariton device 1 may be improved compared to a case in which the upper reflective layer 11 is formed by a dry transfer method and the lower reflective layer 12 is formed by a direct deposition method.

The polariton device 1 may further include a Rabi frequency controller 13. The Rabi frequency controller 13 may control the Rabi frequency of the polariton device 1 by providing a stimulus to the gain layer 100. Here, the stimulus may include a temperature change stimulus or an electrical change stimulus.

In some example embodiments, the polariton device 1 may further include a temperature control device. The temperature control device may provide a temperature change stimulus to the gain layer 100. For example, the polariton device 1 may further include a substrate having an upper surface supporting the lower reflective layer 12, and the temperature control device may be formed to be attached to the lower surface of the substrate. Here, the temperature control device may be, for example, a micro temperature varying unit. The Rabi frequency controller 13 may control the Rabi frequency of the polariton device 1 by changing the temperature change stimulus provided to the gain layer 100 through the temperature control device.

In some other example embodiments, the polariton device 1 may further include an electrical control device. The electrical control device may provide an electrical change stimulus to the gain layer 100. For example, an electrode may be formed on the gain layer 100, and an electrical control device may be electrically connected to the gain layer 100 through the electrode. Here, the electrical control device may be implemented in the form of a capacitor that may apply an electric field to the gain layer 100, for example. The Rabi frequency controller 13 may control the Rabi frequency of the polariton device 1 by changing the temperature change stimulus provided to the gain layer 100 through the electrical control device.

Meanwhile, the polariton device 1 may be implemented in the form of a chip and applied to quantum information technology (e.g., quantum communication, a quantum sensor, a quantum logic circuit, etc.). In particular, the polariton device 1 may also be applied to the generation of qubits which may be controlled in quantum state and which may be used in quantum devices. For example, the polariton device 1 may further include a qubit generating unit 14.

The qubit generating unit 14 may generate a polariton qubit implemented based on polariton. Specifically, the Rabi frequency controller 13 may control a probability distribution of an upper polariton or a lower polariton of the polariton device 1 by providing a stimulus to the gain layer 100, and the qubit generating unit 14 may generate a qubit with an occupation state determined according to the controlled probability distribution.

Polaritons may be generated from strong coupling between excitons and photons, which may lead to the formation of a mode having two new energy levels. The two modes are divided into upper polaritons and lower polaritons, each of which is in a state of partial hybridization of exciton and photon properties. These two states of polaritons may be used to define a qubit. In other words, the state of the qubit may be determined by the probability of occupation of upper polaritons and lower polaritons. The probability of occupation may be affected by the ratio of exciton and photon components, energy transfer or decay process over time, etc. A change in the Rabi oscillation frequency according to example embodiments may change the distribution of exciton and photon components in upper polaritons and lower polaritons, which may affect the energy decay process to generate polariton qubits with various occupation states. At this time, the probability of occupying each polariton state may be determined depending on the components of excitons and photons, energy transfer or decay process over time, etc. In other words, as the polariton Rabi oscillation frequency changes, the number of particles occupied in the upper polariton and lower polariton states changes, which may change polariton qubit states and generate qubits in various states.

In the related art, it was common to change a design structure of a polariton device or adopt a complex system to change the Rabi frequency of the polariton device. For example, in order to change the Rabi frequency, a length of the cavity was adjusted or a device structure was changed to change a quality factor. Alternatively, the exciton energy was adjusted using a separate magnet capable of applying a magnetic field, but a magnet large enough to generate a very high level of magnetic field was needed.

In the case of the polariton device 1 according to the present example embodiment, as a ferroic material is included in the gain layer, the symmetry of crystal reversibly undergoes a phase transition to an asymmetrical crystal structure in response to a temperature change stimulus or an electrical change stimulus and spontaneous polarization may be induced to change the exciton oscillator strength. Accordingly, the Rabi frequency of the polariton device formed by the interaction of the state of the exciton and the photon may be controlled without changing a design structure of the polariton device or adopting a complicated system. For example, a large Rabi oscillation frequency change of up to ˜20% (˜13 meV) may be induced even with a small temperature change of 80 K. In addition, it may be used as a qubit by controlling the probability distribution of upper polaritons and lower polaritons, making it applicable to various fields including quantum information technology.

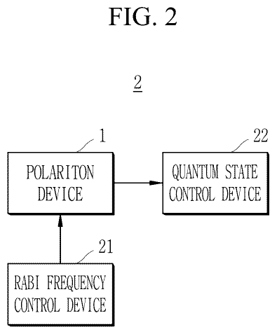

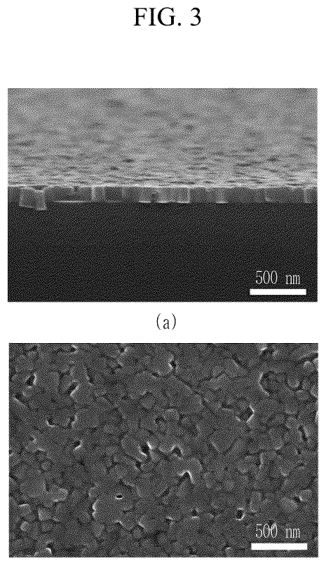

FIG. 2 is a diagram illustrating a polariton system according to an example embodiment.

Referring to FIG. 2, a polariton system 2 according to an example embodiment may include the polariton device 1, a Rabi frequency control device 21, and a quantum state control device 22.

The polariton device 1 may include a gain layer including a ferroic material that undergoes a phase transition into an asymmetrical crystal structure in response to an external stimulus, and the Rabi frequency control device 21 may control the Rabi frequency of the polariton device (1) by providing a stimulus to the polariton device 1.

The quantum state control device 22 may control a quantum state based on the controlled Rabi frequency. In some example embodiments, in relation to the field of quantum computing, the quantum state control device 22 may provide qubits for a quantum computer that are generated by controlling the quantum state. In other words, quantum operations may be performed by utilizing the generation of polariton qubits with different occupations of upper polaritons and lower polaritons, which change as the Rabi oscillation strength changes, as quantum bits. In some other example embodiments, in relation to the field of quantum encryption, the quantum state control device 22 may control the level of quantum encryption by controlling the quantum state. In other words, a change in the Rabi oscillation strength may generate various quantum states, which means that security may be strengthened by expressing the quantum encryption method more complexly. In some other example embodiments, in relation to the field of optical modulators, the quantum state control device 22 may finely adjust the strength of an optical signal for an optical modulator by controlling the quantum state. An optical modulator is a device that adjusts the strength, phase, and frequency of optical signals and may be used in light-based communications, information processing, and sensing. If the polariton Rabi oscillation strength may be controlled, it is possible to finely adjust the strength of an optical signal, so the frequency may be adjusted and used in a multi-frequency communication system. In addition, by modulating the phase, high-quality optical communication may be achieved by increasing a transfer rate with higher data density and reducing signal interference.

FIG. 3 is a diagram illustrating an implementation example of a gain layer according to an example embodiment.

Referring to FIG. 3, the gain layer according to an example embodiment may be formed as a thin film. Here, the gain layer may include MAPbBr₃ as a ferroic material. Specifically, in a nitrogen atmosphere, the MAPbBr₃ thin film may be rotated at 3600 rpm for 60 seconds using a spin coater, and while maintaining rotation, 100 μl of chloroform may be slowly dropped over 20 seconds to form a thin film having a nano grain size. In addition, the stability of the thin film may be increased by coating a polymethyl methacrylate (PMMA) layer on top of the thin film manufactured by curing at 100° C. for 10 minutes. (a) shows a scanning electron microscope (SEM) photograph of a gain layer formed with polygrain to have a thickness of 124 nm, and (b) shows a surface SEM photograph of the gain layer formed by the same manufacturing method viewed from above.

In some example embodiments, the upper and lower reflective layers formed above and below the gain layer may be manufactured as a distributed Bragg reflector having a multilayer structure including ZnS as a high refractive index dielectric thin film and MgF₂ as a low refractive index dielectric thin film. The upper and lower reflective layers may be formed using an electron beam evaporator at a deposition rate of 10 Å/s for MgF₂ and 5 Å/s for ZnS, and in a 11.5 period for the lower reflective layer. In the case of the upper reflective layer, a micro-sized multilayer distributed Bragg reflector formed with a 5.5 period may be formed to be located on top of the cavity using a dry transfer method.

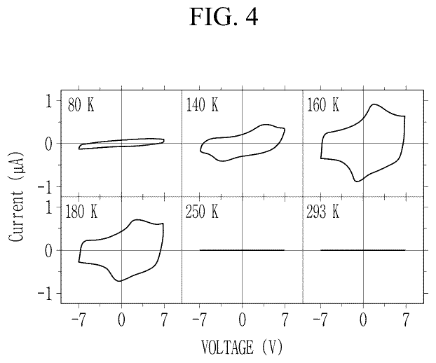

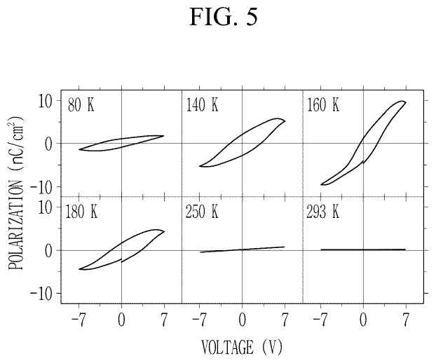

FIG. 4 is a diagram illustrating current switching characteristics of a ferroic material according to an example embodiment, and FIG. 5 is a diagram illustrating polarization characteristics of a ferroic material according to an example embodiment.

Referring to FIGS. 4 and 5, as for MAPbBrs, which is adopted as a ferroic material of the gain layer, a material internal polarization may be formed at a temperature having a tetragonal structure. FIGS. 4 and 5 show dielectric polarization characteristics using a current-voltage hysteresis curve and polarization voltage hysteresis curve measurement method in a capacitor-type electric device using a bulk MAPbBr₃ crystal. MAPbBr₃ is orthorhombic in the temperature range from 77 K to 130 K, tetragonal in the temperature range from 130 K to 210 K, and cubic in the temperature range of 210 K or higher, and a macroscopic polarization state in the tetragonal system may be confirmed by measuring a current-voltage hysteresis curve and polarization-voltage hysteresis curve measured at representative temperatures for the three phases.

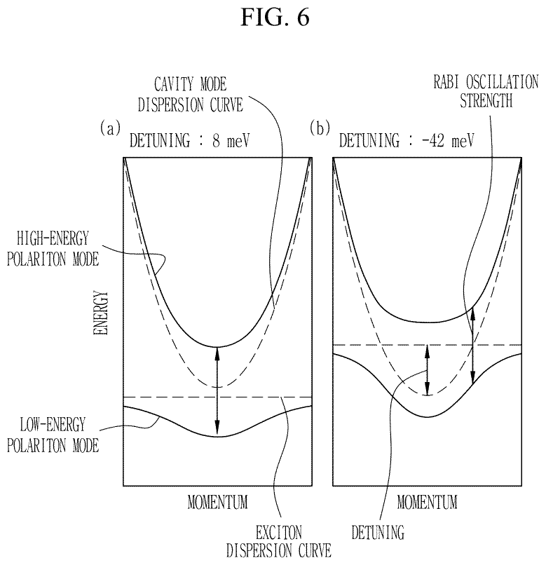

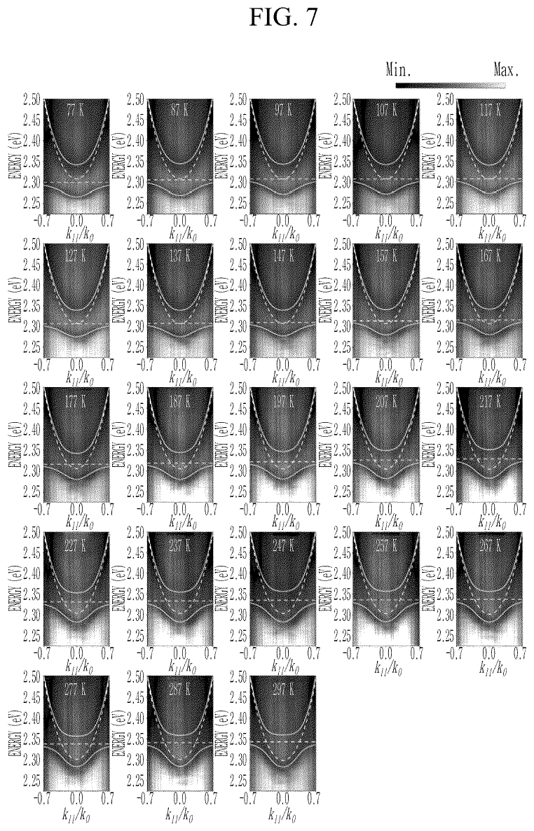

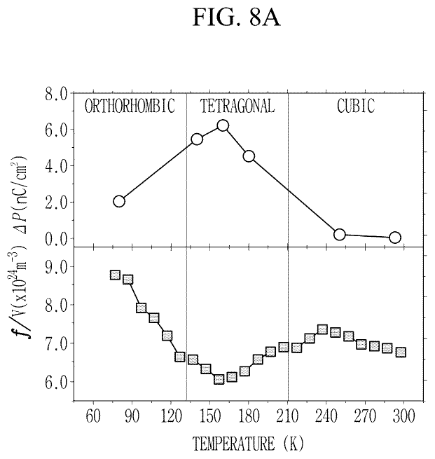

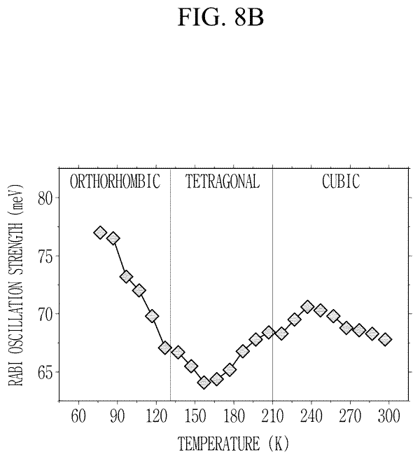

FIGS. 6 and 7 are diagrams illustrating dispersion curves of a polariton device according to an example embodiment, FIG. 8A is a diagram illustrating an example of a change in exciton oscillator strength by a polariton device according to an example embodiment, and FIG. 8B is a diagram illustrating an example of a change in Rabi frequency by a polariton device according to an example embodiment.

A change in the Rabi oscillation frequency of a polariton device due to a temperature change may be checked using angle-resolved reflection measurement. As shown in FIG. 6, a polariton dispersion curve in which the resolved angle corresponds to the x-axis in momentum space and the y-axis represents energy for the momentum space may be checked. An energy difference between an upper polariton and a lower polariton at a momentum in which a difference between the exciton energy of the polariton device and a cavity mode energy is smallest may be defined as the Rabi oscillation strength, and the Rabi oscillation frequency may be related to the Rabi oscillation strength.

In the polariton dispersion curve shown in FIG. 6, the difference between the exciton energy and the cavity mode energy at a point in which the momentum is 0 is detuning, and thus, the momentum that defines the Rabi oscillation strength may be defined to be different depending on the detuning. As shown in FIG. 7, the Rabi oscillation strength may be derived from the dispersion curve of the polariton device according to temperature.

FIG. 8A shows the exciton oscillator strength over temperature, where AP is the size of remanent polarization and may represent the degree of polarization remaining after removing voltage (or electric field). A large remanent polarization may be interpreted as the presence of a large spontaneous electric dipole moment inside a material. In the tetragonal phase in which the remanent polarization is large, the exciton oscillator strength is the smallest, and the exciton oscillator strength has a proportional relationship with the Rabi frequency, so the exciton oscillator strength may change correspondingly depending on the size of the remanent polarization. Next, referring to FIG. 8B, it can be seen that the Rabi frequency changes in response to the exciton oscillator strength. In FIG. 8B, the Rabi oscillation strength is expressed, and since the Rabi oscillation strength is a value obtained by multiplying the Rabi frequency by Planck constant, the Rabi oscillation strength is a value proportional to the Rabi frequency and may be considered as representing the same scale. In other words, the exciton oscillator strength is affected through control of the ferroicity, based on which the Rabi frequency, which is the interaction between the exciton and the photon, changes.

For example, depending on the temperature change, the Rabi oscillation strength may change by ˜13 meV, from a maximum of 77 meV to 64 meV.

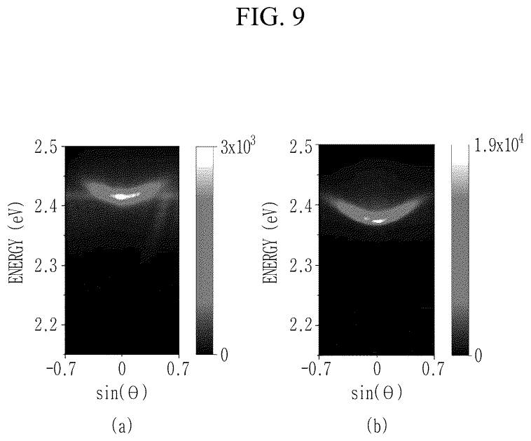

FIG. 9 is a diagram illustrating a dispersion curve when the upper reflective layer is formed using different methods in a polariton device according to an example embodiment.

In the case of the upper reflective layer of the polariton device, the method of dry transferring a micro-sized multilayer distributed Bragg reflector may be changed. Specifically, a multilayer distributed Bragg reflector may be formed through direct deposition on top of the cavity of the polariton device using an E-beam evaporator. In FIG. 9, (a) is a dispersion curve of a polariton device when the upper reflective layer is formed by a dry transfer method, and (b) is a dispersion curve of a polariton device when the upper reflective layer is formed by a direct deposition method. In both (a) and (b), the lower reflective layer is formed by the direct deposition method. By changing the method of forming the upper reflective layer, the quality factor of the polariton device may be improved due to the effect of stronger contact with the cavity and the surface of the polariton device may be ensured to be flat. As shown in (b), it can be seen that the quality factor of the polariton device is improved as a curve width (broadening) decreases.

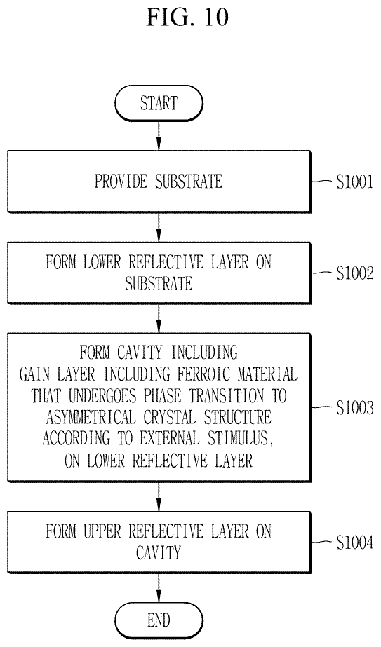

FIG. 10 is a diagram illustrating a method of manufacturing a polariton device according to an example embodiment.

Referring to FIG. 10, a method of manufacturing a polariton device according to an example embodiment may include providing a substrate (S1001), forming a lower reflective layer on the substrate (S1002), forming a cavity including a gain layer including a ferroic material that undergoes a phase transition to an asymmetrical crystal structure in response to an external stimulus, on the lower reflective layer (S1003), and forming an upper reflective layer on the cavity (S1004). Here, the Rabi frequency of the polariton device may be controlled according to the stimulus provided to the gain layer.

In some example embodiments, the method may further include forming a temperature control device on a lower surface of the substrate, and the Rabi frequency of the polariton device may be controlled according to a temperature change stimulus provided to the gain layer through the temperature control device.

In some example embodiments, operation S1003 may further include forming an electrode in the gain layer, the method may further include connecting the electrical control device through the electrode, the Rabi frequency of the polariton device may be controlled according to an electrical change stimulus provided to the gain layer through the electrical control device.

For further details on the above method, the example embodiments described in this specification may be referred to, so a redundant description is omitted here.

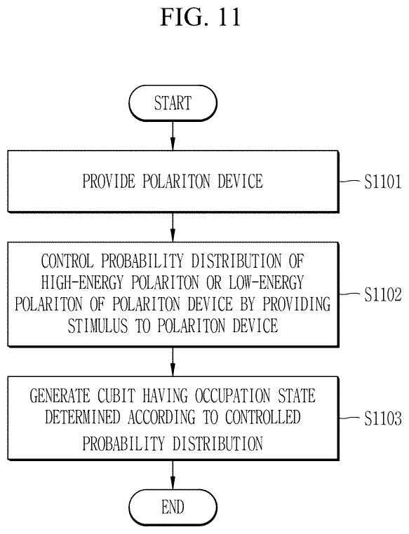

FIG. 11 is a diagram illustrating a method of controlling a polariton device according to an example embodiment.

Referring to FIG. 11, a method of controlling a polariton device according to an example embodiment may include providing a polariton device manufactured by the method according to the example embodiments (S1101), controlling a probability distribution of an upper polariton or a lower polariton by providing a stimulus to the polariton device (S1102), and generating a qubit with an occupation state determined according to the controlled probability distribution (S1103).

In some example embodiments, the method may further include generating a qubit having an occupation state is determined according to a controlled probability distribution.

For further details on the above method, the example embodiments described in this specification may be referred to, so a redundant description is omitted here.

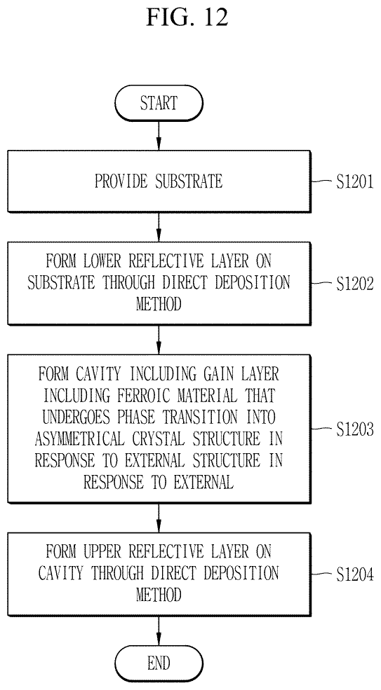

FIG. 12 is a diagram illustrating a method of manufacturing a polariton device according to an example embodiment.

Referring to FIG. 12, a method of manufacturing a polariton device according to an example embodiment includes providing a substrate (S1201), forming a lower reflective layer on the substrate by a direct deposition method (S1202), forming a cavity including a gain layer including a ferroic material that undergoes a phase transition into an asymmetrical crystal structure in response to an external stimulus, on the lower reflectively layer (S1203), and forming an upper reflective layer on the cavity by a direct deposition method (S1204).

For further details on the above method, the example embodiments described in this specification may be referred to, so a redundant description is omitted here.

According to the example embodiments described so far, as a ferroic material is included as a gain layer, the symmetry of crystal may reversibly undergo a phase transition to an asymmetrical crystal structure in response to a temperature change stimulus or an electrical change stimulus, and spontaneous polarization may be induced inside a material to change the strength of an oscillator of an exciton. Accordingly, the Rabi frequency of the polariton device formed by the interaction of the state of the exciton and the photon may be controlled without changing a design structure of the polariton device or adopting a complicated system.

While the disclosure has been described in connection with example embodiments, it is to be understood that the invention is not limited to the disclosed example embodiments, but, on the contrary, is intended to cover various modifications and equivalent arrangements included within the spirit and scope of the appended claims.

What is claimed is:

1. A polariton device comprising:
a cavity including a gain layer including a ferroic material that undergoes a phase transition into an asymmetrical crystal structure in response to an external stimulus;
an upper reflective layer formed on top of the cavity;
a lower reflective layer formed below the cavity; and
a Rabi frequency controller configured to control a Rabi frequency of the polariton device by providing a stimulus to the gain layer.

2. The polariton device of claim 1, wherein:
the ferroic material includes a perovskite material having an ABX₃ structure (A: positive ion, B: metal ion, C: halogen ion or oxygen).

3. The polariton device of claim 1, further comprising:
a temperature control device configured to provide a temperature change stimulus to the gain layer,
wherein the Rabi frequency controller controls the Rabi frequency of the polariton device by changing the temperature change stimulus provided to the gain layer through the temperature control device.

4. The polariton device of claim 3, further comprising:
a substrate having an upper surface supporting the lower reflective layer,
wherein the temperature control device is formed to be attached to a lower surface of the substrate.

5. The polariton device of claim 1, further comprising:
an electrical control device configured to provide an electrical change stimulus to the gain layer,
wherein the Rabi frequency controller controls the Rabi frequency of the polariton device by changing an electrical change stimulus provided to the gain layer through the electrical control device.

6. The polariton device of claim 5, wherein:
an electrode is formed in the gain layer, and
the electrical control device is electrically connected to the gain layer through the electrode.

7. The polariton device of claim 1, further comprising:
a qubit generating unit configured to generate a polariton qubit implemented based on polariton,
wherein the Rabi frequency controller controls a probability distribution of an upper polariton or a lower polariton of the polariton device by providing a stimulus to the gain layer, and
the qubit generating unit generates a qubit having an occupation state determined depending on the controlled probability distribution.

8. The polariton device of claim 1, wherein:
at least one of the upper reflective layer and the lower reflective layer is formed by alternately stacking first and second dielectric layers having different refractive indices, a refractive index of the first dielectric layer is greater than a refractive index of the second dielectric layer,
the first dielectric layer includes at least one of ZnS, TiO₂, Si₃N₄, Nb₂O₅, ZnSe, and Ta₂O₅,
the second dielectric layer includes at least one of SiO₂ and MgF₂, and
the ferroic material includes MAPbBrs, MAPbl₃, MAPbCl₃, CsPbBrs, or BiFeO₃.

9. The polariton device of claim 8, wherein:
the upper reflective layer is formed on top of the cavity according to a direct deposition method.

10. A polariton system including a polariton device, the polariton system comprising:
a polariton device including a gain layer including a ferroic material that undergoes a phase transition into an asymmetrical crystal structure in response to an external stimulus;
a Rabi frequency control device configured to control a Rabi frequency of the polariton device by providing a stimulus to the polariton device; and
a quantum state control device configured to control a quantum state based on the controlled Rabi frequency.

11. The polariton system of claim 10, wherein:
the quantum state control device provides a qubit for a quantum computer generated by controlling the quantum state.

12. The polariton system of claim 10, wherein:
the quantum state control device controls a quantum encryption level by controlling the quantum state.

13. The polariton system of claim 10, wherein:
the quantum state control device finely adjusts strength of an optical signal for an optical modulator by controlling the quantum state.

14. A method of manufacturing a polariton device, the method comprising:
providing a substrate;
forming a lower reflective layer on the substrate;
forming a cavity, including a gain layer including a ferroic material that undergoes a phase transition into an asymmetrical crystal structure in response to an external stimulus, on the lower reflective layer; and
forming an upper reflective layer on the cavity,
wherein the Rabi frequency of the polariton device is controlled according to a stimulus provided to the gain layer.

15. The method of claim 14, wherein:
the ferroic material includes a perovskite material having an ABX₃ structure (A: positive ion, B: metal ion, C: halogen ion or oxygen).

16. The method of claim 14, further comprising:
forming a temperature control device on a lower surface of the substrate,
wherein the Rabi frequency of the polariton device is controlled according to a temperature change stimulus provided to the gain layer through the temperature control device.

17. The method of claim 14, wherein:
the forming of the cavity further includes
forming an electrode on the gain layer, and
wherein the method further comprising:
connecting an electrical control device through the electrode,
wherein the Rabi frequency of the polariton device is controlled according to an electrical change stimulus provided to the gain layer through the electrical control device.

18. The method of claim 14, wherein:
the forming of the upper reflective layer includes
forming the upper reflective layer on the cavity according to a direct deposition method.

19. A method of controlling a polariton device, the method comprising:
providing a polariton device manufactured by the method of manufacturing a polariton device according to claim 15; and
controlling a probability distribution of an upper polariton or a lower polariton of the polariton device by providing a stimulus to the polariton device.

20. The method of claim 19, further comprising:
generating a qubit with an occupation state determined according to the controlled probability distribution.
